(19) United States
(12) Patent Application Publication
(10) Pub. No.: US 2007/0173113 A1
(43) Pub. Date: Jul. 26, 2007

(54) Part positioning method and apparatus

(76) Inventors: Masaru Maruo, Saitama (JP); Takao Shibayama, Saitama (JP)

Correspondence Address: ARENT FOX PLLC, 1050 CONNECTICUT AVENUE, N.W., SUITE 400, WASHINGTON, DC, 20036, US

(21) Appl. No.: 10/589,083

(22) PCT Filed: Jan. 7, 2005
(86) PCT No.: PCT/JP05/00114

§ 371 Date: Aug. 11, 2006

(30) Foreign Application Priority Data
Feb. 12, 2004 (JP) 2004-035503

(51) Int. Cl. H01R 13/73

(52) U.S. Cl. 439/564

(57) ABSTRACT

A part positioning apparatus comprises a target marker (2a) provided on a tip end of a wire (2b) to be set on a motor vehicle body (W), a sensed member for accommodating the wire (2b) in such a state as to be pulled out and wound up, a first sensor (3) for detecting a pulled-out length of the wire (2b) when the target marker (2a) is set on the motor vehicle body (W), a second sensor (4) for detecting an existing location of the wire (2b) when the target marker (2a) is set on the motor vehicle body (W), and a controller means (5) for controlling a traveling amount of the self-traveling machine (1) such that each of detection values of the first sensor (4) and the second sensor (5) becomes a given value.

### TECHNICAL FIELD

The present invention relates to a method of and an apparatus for positioning a part, in which a part supported or carried by a self-traveling machine is positioned with respect to an object such as a motor vehicle body or the like to which the part is to be fitted.

### BACKGROUND ART

As a part positioning apparatus for positioning a part in relation to a part fitting object, there is known such an apparatus that comprises a movable table for holding the part to be fitted to a bottom surface of the part fitting object (work), a relative position detecting means for detecting a relative position of the movable table with respect to the work, a table positioning means for moving, based on a signal from the relative position detecting means, the movable table within the same imaginary plane so as to position the movable table in a predetermined relative position with respect to a predetermined position of the bottom surface of the work, a table lifting means for having the movable table moved up and down under the work, and a part assembling means, mounted on the movable table, for fitting the part held by the table lifting means to the bottom surface of the work under the lifted and positioned condition of the movable table (for example, see Patent Document 1).

Patent Document 1: Japanese patent application publication No. S63-93530.

### DISCLOSURE OF THE INVENTION

### Problem to be Solved by the Invention

The part positioning apparatus disclosed in Patent Document 1, however, has such a disadvantage that a television camera, which is used as the relative position detecting means of the movable table with respect to the work, may not function accurately dependent on the working environment such as the brightness of a working site, the existence of disturbance light, etc.

The present invention is made in view of the above mentioned disadvantage of the prior art and has its object to provide a part positioning method and a part positioning apparatus which are capable of easily and reliably positioning a part supported or carried by a self-traveling machine with respect to a part fitting object such as a motor vehicle body or the like, and which are good in workability.

### MEANS FOR SOLVING THE PROBLEM

To solve the above mentioned disadvantage, according to the present invention as referred to in claim 1, there is provided a part positioning method in which a part supported by a self-traveling machine is positioned with respect to an object to which the part is to be fitted, comprising the steps of: setting on the part fitting object an engaging means provided on a tip end of a wire member which is possible to be pulled out and wound up, detecting a pulled-out length and an existing location of the wire member and moving the self-traveling machine to eliminate relative positional discrepancies between the part fitting object and the part, fitting the part to the part fitting object in the state that the positional discrepancies are eliminated, and, after fitting the part to the part fining object, removing and retrieving the engaging means from the part fitting object.

According to the present invention as referred to in claim 2, there is provided a port positioning apparatus for positioning a part supported by a self-traveling machine with respect to a part fitting object, comprising an engaging means being provided on a tip end of a wire member to be set on the part fitting object, a sensed member for accommodating the wire member in such a state as to be pulled out and wound up, a first sensor for detecting a pulled-out length of the wire member when the engaging means is set on the part fitting object, a second sensor for detecting an existing location of the wire member when the engaging means is set on the part fitting object, and a controller means for controlling a traveling amount of the self-traveling machine such that each of detection values of the first sensor and the second sensor is in agreement with a reference value.

### EFFECTS OF THE INVENTION

As explained above, according to the present invention, the part may be automatically positioned with respect to the part fitting object without being influenced by the working environment merely by setting the engaging means on the part fitting object.

### BRIEF DESCRIPTION OF THE DRAWINGS

FIG. 1 is a schematic explanatory view of a part positioning apparatus according to the present invention;

FIG. 2(a) is an explanatory view of sensors and (b) is an explanatory view of control operation thereof;

FIG. 3 is a block diagram showing a control system;

FIG. 4 is a flow chart showing operation steps of a part positioning method according to the present invention; and

FIG. 5 is an explanatory view of operation, wherein (a) shows a synchronized follow-up state, (b) shows a setting state of target markers, (c) shows a positioning and fitting state of a part, and (d) shows a retrieved state of the target markers.

### BEST MODE FOR CARRYING OUT THE INVENTION

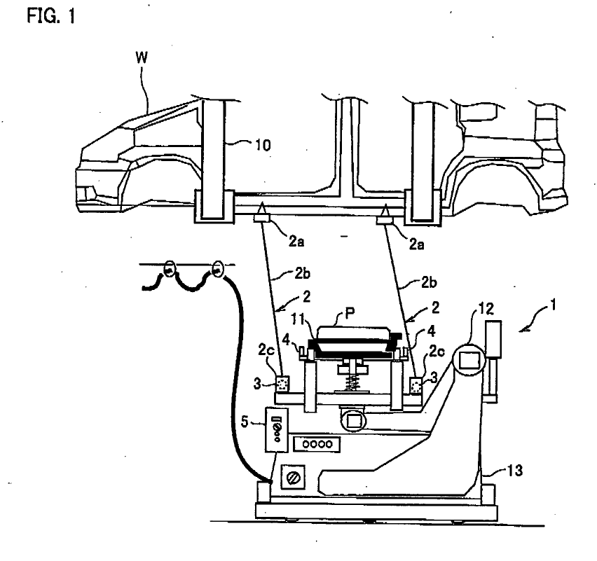

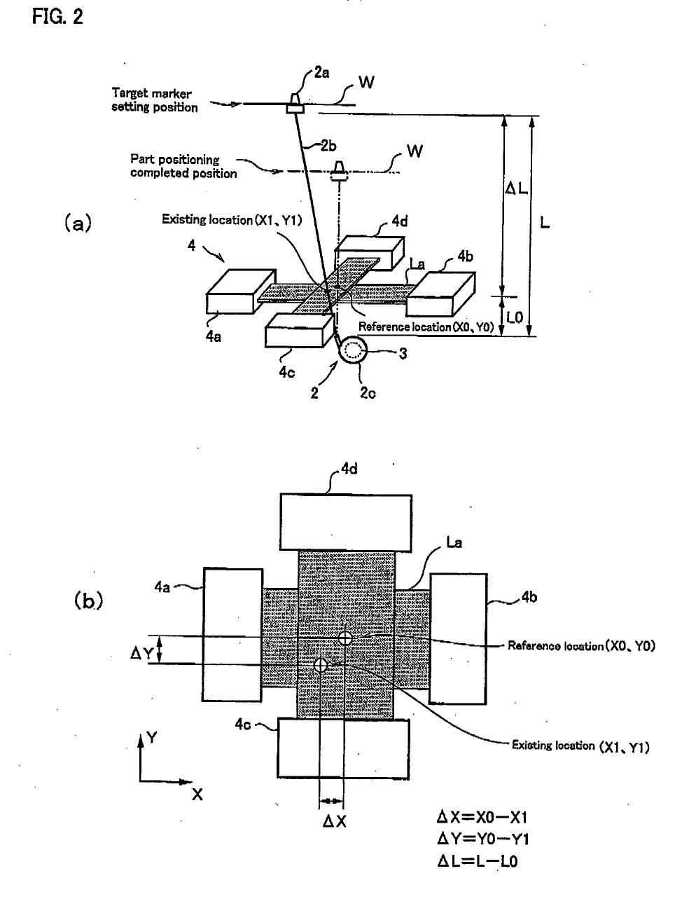

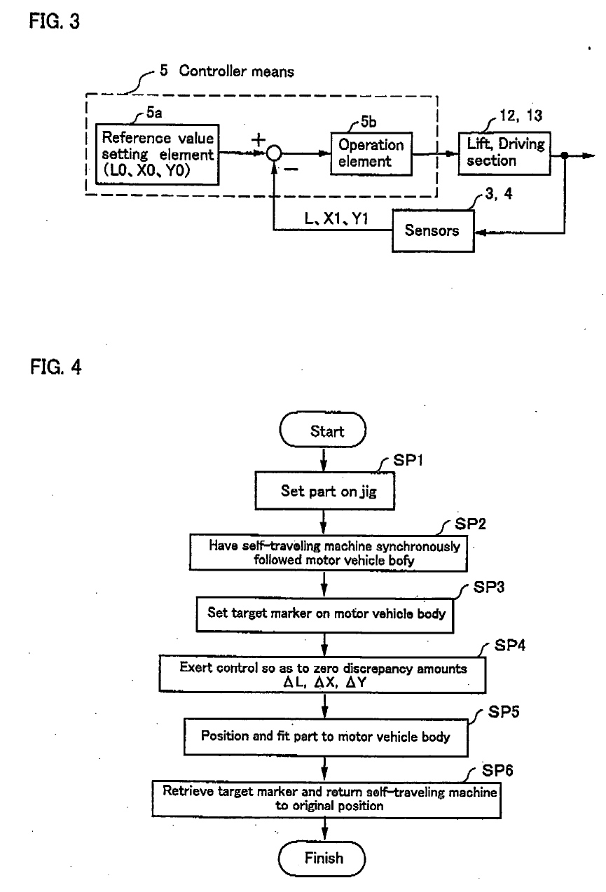

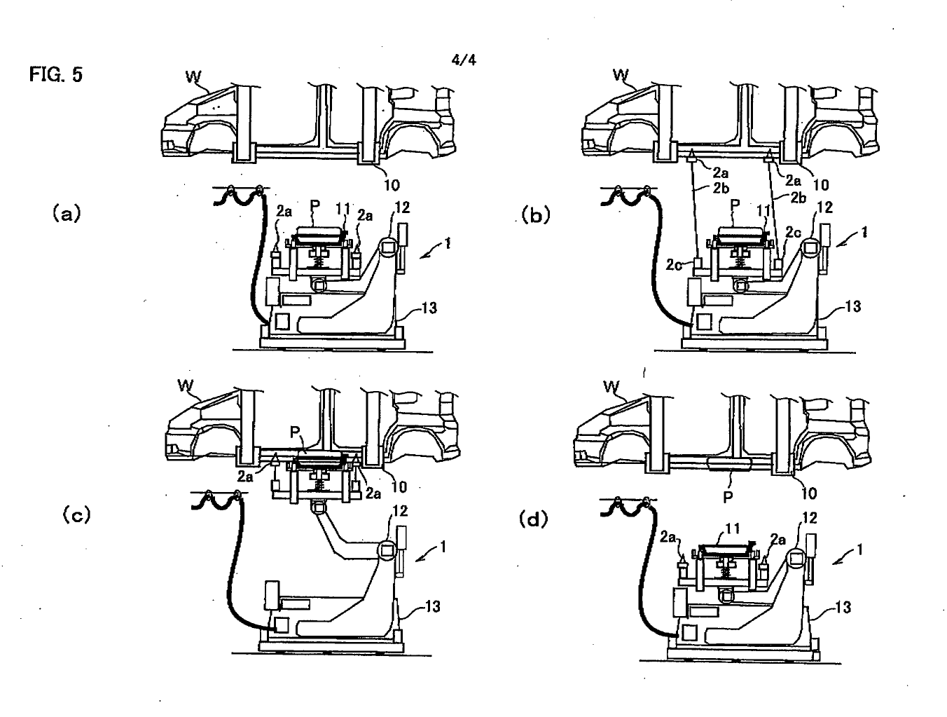

An embodiment of the present invention will now be explained with reference to the accompanying drawings. Herein, FIG. 1 is a schematic explanatory view of a part positioning apparatus according to the present invention, FIG. 2 is an explanatory view of sensors and the control operation thereof, FIG. 3 is a block diagram showing a control system, FIG. 4 is a flow chart showing operation steps of a part positioning method according to the present invention, and FIG. 5 is an explanatory view of operation.

As shown in FIG. 1, the part positioning apparatus according to the present invention comprises a self-traveling machine 1, sensed members 2, first sensors 3, second sensors 4, a controller means 5, and the like. The sensed members 2, the first sensors 3, the second sensors 4 and the controller means 5 are mounted on the self-traveling machine 1. The self-traveling machine 1 is a device for supporting a part P to be fitted to a bottom surface of a motor vehicle body W, that is an object to fit a part thereto, which is loaded and carried by an overhead hanger 10, and for fitting the part P to the motor vehicle body W in synchronized movement with the motor vehicle body W. The self-traveling machine 1 is provided with a jig 11 for supporting or carrying the part P, a lift 12 for having the jig 11 moved up and down, a driving section 13, a fastening machine (not shown), and the like.

In the embodiment of the present invention, a set of the sensed member 2, the first sensor 3 and the second sensor 4 are arranged on front and rear sides of the self-traveling machine 1, so that the part P can be positioned two-dimensionally (on a plane) with respect to the motor vehicle body W.

Accordingly, there is no case where the part P is positioned in a twisted condition with respect to the motor vehicle body W, and the part P can be accurately fitted to the motor vehicle body W.

The sensed members 2 comprise target markers (engaging means) 2a which are provided to be set on predetermined positions of the bottom surface of the motor vehicle body W, wires (wire members) 2b on the tip ends of which the target markers 2a are fitted, and wire winding means 2c which accommodate the wires 2b in such a state as to be pulled out and wound up.

Each of the first sensors 3, as shown in FIG. 2, is formed of a rotary encoder for detecting a pulled-out length of the wire 2b when the target marker 2a is set on the predetermined position of the bottom surface of the motor vehicle body W. The first sensor 3 is mounted on a rotary shaft of the wire winding means 2c of the sensed member 2 so as to calculate the pulled-out length of the wire 2b based on the number of rotation (rotation angle) when the wire 2b is pulled out and wound up.

A reference length L0 of the pulled-out length of the wire 2b is set at the pulled-out length of the wire in such a state that the part P is positioned with respect to the predetermined position of the bottom surface of the motor vehicle body W.

Each of the second sensors 4, as shown in FIG. 2, is formed of a displacement sensor for detecting an existing location (X1, Y1) of the wire 2b on a plane (in two-dimensions) when the target marker 2a is set on the predetermined position of the bottom surface of the motor vehicle body W.

The second sensor 4 is provided with a couple of a light projector 4a and a light receiver 4b and another couple of a light projector 4c and a light receiver 4d such that a belt-shaped laser beam La emitted from the light projector 4a and a belt-shaped laser beam La emitted from other light projector 4c intersect at right angles to each other so as to form a detection area D on an X•Y plane in the intersecting area of the laser beams La.

With this construction, when the wire 2b passes through the detection area D, the wire 2b intercepts the laser beam La, so that the wire passing location (X1, Y1) is detected by the light receivers 4b, 4d. A reference location (X0, Y0) of the wire 2b is located in a center of the detection area D. The reference location (X0, Y0) corresponds to a position where the wire 2b passes through the detection area (the position where the wire 2b is perpendicular to the detection area D on the X•Y plane) when the part P is positioned with respect to the predetermined position of the bottom surface of the motor vehicle body W.

As shown in FIG. 3, the controller means 5 comprises a reference value setting element 5a for setting the reference values L0, (X0, Y0), an operation element 5b for supplying to the lift 12 and the driving section 13 a control input which corresponds to an amount of deviation (an amount of discrepancy) between the reference values L0, (X0, Y0) and the existing values L, (X1, Y1), and the like.

Further, the controller means 5 controls the lift 12 and the driving section 13 of the self-traveling machine 1 in such a fashion that the detection value (existing value) L of the first sensor 3 and the detection value (existing value) (X1, Y1) of the second sensor 4 are in agreement with the reference values L0, (X0, Y0). Namely, as shown in FIG. 2, the driving section 13 of the self-traveling machine 1 is feedback controlled such that the discrepancy amount ΔL(=L−L0) of the pulled-out length of the wire 2b and the discrepancy mount Δ(=X0−X1), ΔY(=Y0−Y1) of the existing location of the wire 2b are zeroed.

Operation of the part positioning method and the part positioning apparatus according to the present invention will now be explained hereunder with reference to the operation steps in FIG. 4.

First, in step SP1, the part P is set on the jig 11 in the lowered state of the lift 12 of the self-traveling machine 1 that is in its original position.

Next in step SP2, as shown in FIG. 5(a), the self-traveling machine 1 with the part P set on the jig 11 is driven substantially at the same speed with the motor vehicle body W loaded and cared by the overhead hanger 10 so as to synchronously follow the motor vehicle body W.

In step SP3, as shown in FIG. 5(b), an operator holds the target markers 2a and pulls out the wires 2b from the wire winding means 2c so as to set the two target markers 2a each on the predetermined positions of the bottom surface of the motor vehicle body W.

Then, in step SP4, the lift 12 and the driving section 13 of the self-traveling machine 1 are feedback controlled such that the discrepancy amount ΔL(=L−L0) of the pulled-out length of the wire 2b and the discrepancy mount ΔX(=X0−X1), ΔY(=Y0−Y1) of the existing location of the wire 2b are zeroed.

Next in step SP5, as shown in FIG. 5(c), the part P is positioned with respect to the predetermined position of the bottom surface of the motor vehicle body W by the lift 12 and the driving section 13 of the self-traveling machine 1, whereby the part P is fitted to the motor vehicle body W by the fastening machine.

In step SP6, as shown in FIG. 5(d), the operator removes and retrieves the two target markers 2a from the motor vehicle body W after checking that the part P is accurately fitted to the motor vehicle body W. Then, when the self-traveling machine 1 is automatically driven and returns to its original position, the fitting operation of the part P is completed.

### INDUSTRIAL APPLICABILITY

According to the present invention, the part may be automatically positioned with respect to the part fitting object without being influenced by the working environment merely by setting the engaging means on the part fitting object. Thus, the present invention contributes to the simplified automation of assembling lines in a motor vehicle production plant, etc.

1. A part positioning method in which a part supported by a self-traveling machine is positioned with respect to a part fitting object, comprising the steps of:
setting on said part fitting object an engaging means provided on a tip end of a wire member which is possible to be pulled out and wound up;
detecting a pulled-out length and an existing location of said wire member and moving said self-traveling machine to eliminate relative positional discrepancies between said part fitting object and the part;
fitting the part to said part fitting object in the state that the positional discrepancies are eliminated; and
after fitting the part to said part fitting object removing and retrieving said engaging means from said part fitting object.

2. A part positioning apparatus for positioning a part supported by a self-traveling machine with respect to a part fitting object, comprising:
an engaging means being provided on a tip end of a wire member so as to be set on said part fitting object;
a sensed member for accommodating said wire member in such a state as to be pulled out and wound up;
a first sensor for detecting a pulled-out length of said wire member when said engaging means is set on said part fitting object;
a second sensor for detecting an existing location of said wire member when said engaging means is set on said part fitting object; and
a controller means for controlling a traveling amount of said self-traveling machine such that each of detection values of said first sensor and said second sensor is in agreement with a reference value.
